(19) United States
(12) Patent Application Publication
(10) Pub. No.: US 2004/0153502 A1
(43) Pub. Date: Aug. 5, 2004

(54) Enhanced DNS server

(76) Inventor: Luliang Jiang, Beijing (CN)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/715,467

(22) Filed: Nov. 19, 2003

Related U.S. Application Data
(60) Provisional application No. 60/444,619, filed on Feb. 4, 2003.

(51) Int. Cl. G06F 15/16

(52) U.S. Cl. 709/203

(57) ABSTRACT

A network element, method and system for performing name resolving in a network system which includes a first network using a first network protocol and a second network using a second network protocol. The network element includes a first connection for providing a direct connection to the first network, a second connection for providing a direct connection to the second network, an address translation unit for performing address translation between the first network and the second network, and a name resolving unit for performing name resolving. The name resolving unit and the address translation unit are adapted to co-operate in order to translate addresses upon performing name resolving, thereby reducing the load on a network address translating element.

The present application claims the benefit of priority of provisional application Serial No. 60/444,619, filed Feb. 4, 2003, the contents of which are incorporated herein by reference.

### FIELD OF THE INVENTION

The present invention relates to a network element and a method for resolving names in a network system comprising a first network using a first network protocol and a second network using a second protocol.

### BACKGROUND OF THE INVENTION

The invention relates to name resolving and address and protocol translation between at least two different networks, each of which using a different protocol. Examples for such different protocol are Internet Protocol version 4 (IPv4) and Internet Protocol version 6 (IPv6). IPv6 is the new version of IP protocol designed to replace the current IPv4. The network transition from IPv4 to IPv6 will last a long time. That is, IPv4 and IPv6 will co-exist for a long time. During the co-existing of IPv6 network and IPv4 network, network translation like Network Address Translation and Protocol Translation (NAT-PT) is the only choice for hosts in native IPv6 network to communicate with hosts in IPv4 network and vice versa.

A NAT-PT server is located in the edge of IPv6 network and IPv4 network. All the traffic between IPv6 network and IPv4 network must traverse the NAT-PT server. For each packet from IPv6 network to IPv4 network or from IPv4 network to IPv6 network, the NAT-PT server performs address and protocol translation. Thus, NAT-PT enables the communication between the two networks.

Hence, there is heavy load on the NAT-PT servers. This is in particular a problem when name resolve requests within the two networks have to be carried out by Domain Name Service (DNS) Servers over the network border. Namely, when dealing with DNS related packets, the NAT-PT server must check almost the whole packet rather than only the head of the packets. This may cause a very high load on the NAT-PT server in connection with name resolve requests.

For a native IPv6 host A, before it makes a connection to another host B in IPv4 network, it must first initiate a name resolve request to a DNS server in IPv6 network in order to get B's IP address. Normally, the DNS server in IPv6 network may forward the request to another DNS server in IPv4 network. Of course, the request must traverse NAT-PT server. The NAT-PT server catches the packet and changes it into an IPv4 request, and then sends it to the DNS server in IPv4 network. When the answer from the DNS server in IPv4 network comes back, NAT-PT server catches it and translates it into IPv6. Then A can communicate with B. This is the normal way that a NAT-PT operates.

In the following, the procedure regarding such a name resolve request is described by referring to FIG. 1 in more detail.

FIG. 1 shows two networks, namely a native IPv6 network and an IPv4 network. A host A is located in the IPv6 network, the address of the host A is in this example 3ffe:0:0:1::1/64. A host B is located in the IPv4 network and the address of host B is 17.0.0.1. In this scenario, A wants to communicate with B. DNS1 is a name server in the IPv6 network, while DNS2 is a name server in the IPv4 network. Both networks are connected via an NAT-PT server denoted with NAT-PT, which has the address prefix 3ffe:0:1:1::/96.

As to the expression of the addresses, the format used in this description is described in the following. An IPv6 address with 128 bits comprises network address and node address. The length of network address is specified by the number after “/”. For example, the address of host A in FIG. 1 is expressed as “3ffe:0:0:1::1/64”, wherein “3ffe:0:0:1::1” is the IPv6 address of host A, and “/64” indicates that its network address length is 64 bits, i.e. the first 64 bits of this IPv6 address (3ffe:0:0:1::1) represent its network address. Therefore, the following 64 bits represent its node address. Similarly, the network address of NAT-PT in FIG. 1 is expressed as “3ffe:0:1:1::/96” which means that the first 96 bits of its address represent its network address. In this case, the following 32 bits of NAT-PT's address represent its node address. In the address translation from IPv4 to IPv6, the network address (first 96 bits) is used as address prefix and this prefix is combined with an IPv4 address with 32 bits (17.0.0.1). Thus, a new 128 bits IPv6 address (3ffe:0:0:1::17.0.0.1) is generated.

In the following, the messages exchanged in the procedure illustrated in FIG. 1 are described. In message 1-1, host A sends a name resolve request to DNS1 in order to get host B's address. In message 1-2, the DNS1 forwards the request to DNS2 after it failed to handle the request by itself (because host B is not located in the IPv6 network). In message 1-3, the NAT-PT catches the request packet, translates it and then forwards it to DNS2 in the IPv4 network. In message 1-4, the DNS2 sends back the answer, which is host B's address, in this example 17.0.0.1. In message 1-5, the NAT-PT catches the answer, translates host B's address into 3ffe:0:1:1::17.0.0.1 (i.e., combines the address prefix of NAT-PT and the address of the host B) and then forwards it to the DNS1. In message 1-6, the DNS1 sends the answer to A. Thus, in message 1-7, the host A can send packets to the address 3ffe:0:1:1::17.0.0.1 in order to communicate with host B. That is, a translation table in the NAT-PT indicates 3ffe:0:1:1::17.0.0.1—17.0.0.1.

As derivable from the above description, all name resolve requests between the two networks have to traverse the NAT-PT server, thus a heavy load is caused on the NAT-PT server.

### SUMMARY OF THE INVENTION

Thus, the object underlying the present invention resides in reducing the load on a network address translating element such as a NAT-PT server.

This object is solved by a network element for performing name resolving in a network system which comprises a first network using a first network protocol and a second network using a second protocol. The network element includes a first connection for providing a direct connection to the first network, a second connection for providing a direct connection to the second network, an address translation unit for performing address translation between the first network and the second network, and a name resolving unit for performing name resolving. The name resolving unit and the address translation unit are adapted to cooperate in order to translate addresses upon performing name resolving.

Alternatively, the object is solved by a method for resolving names in a network system comprising a first network using a first network protocol and a second network using a second protocol. The method includes the steps of processing a name resolve request to obtain an address, and performing address translation between the first and the second network. The name resolve request processing step and the address translation performing step are performed in a dedicated network element for performing name resolving located in the first network and having direct connections to the first network and to the second network.

Thus, according to the invention, the network element for performing name resolving is a dual stack network element having direct connections to both networks. That is, according to the invention, the DNS related translation is moved from the network translation element (e.g., a NAT-PT server) to the network element which performs the name resolving (e.g., a DNS server). Hence, the load on the network address translation element is reduced. Moreover, since it is not necessary to forward name resolve requests via the network address translation element because the network element for resolving name request (e.g., DNS) is able to provide a direct connection to both networks, the number of messages required for a name resolve request is reduced. This reduces the communication load on the whole network system. The network element may be a Domain Name Service (DNS) server.

Moreover, a plurality of network address translating elements for performing network address translation between the two networks may be provided. In this case, a particular network address translating element to be used for a connection between a first host (A) in the first network and a second host (B) in the second network may be selected, and network address translating element information may be added to the resolved address.

In this way, the first host may be forced to use the selected network address translating element. Thus, the load between the plural network address translating elements can be balanced. Hence, the load on a single network translating element can be reduced.

The network address translating element information may be an address prefix. The selection which network address translating element is to be used may be performed based on information regarding the load on the network address translating element. The first protocol may be Internet Protocol version 6 (IPv6), and the second protocol may be Internet Protocol version 4 (IPv4).

Moreover, the invention proposes a system including a network element as defined above and at least two network address translating elements. The network address translating elements are adapted to send load information to the network element. Thus, the network element can reliably obtain the load information necessary to select a network address translating element. The load information may be sent by using Simple Network Management Protocol (SNMP). The name resolving unit of the network element may be adapted to send a name request to a name resolving element (DNS2) located in the second network.

### BRIEF DESCRIPTION OF THE DRAWINGS

FIG. 1 illustrates a procedure for performing name resolving between two different networks according to the prior art,

FIG. 2 shows a basic block diagram of an enhanced DNS server according to an embodiment of the invention,

FIG. 3 shows a flow chart of the basic operation according to the embodiment of the invention,

FIG. 4 shows a flow chart illustrating a translation step of the flow chart in FIG. 3 performed in case a plurality of NAT-PT servers are present, and

FIG. 5 illustrates a procedure for performing name resolving between two different networks according to the embodiment of the invention.

### DETAILED DESCRIPTION OF INVENTION

In the following, a preferred embodiment is described by referring to the enclosed drawings.

According to the present embodiment, a network element for performing name resolving such as a DNS (Domain Name Service) server is enhanced. Namely, the DNS server is dual-stack, which means that it has a direct link connection to a first network using a first protocol (e.g., an IPv6 network) and a direct link connection to a second network (e.g., an IPv4 network) using a second protocol different from the first protocol. Moreover, it has an enhanced module that handles address and protocol translation.

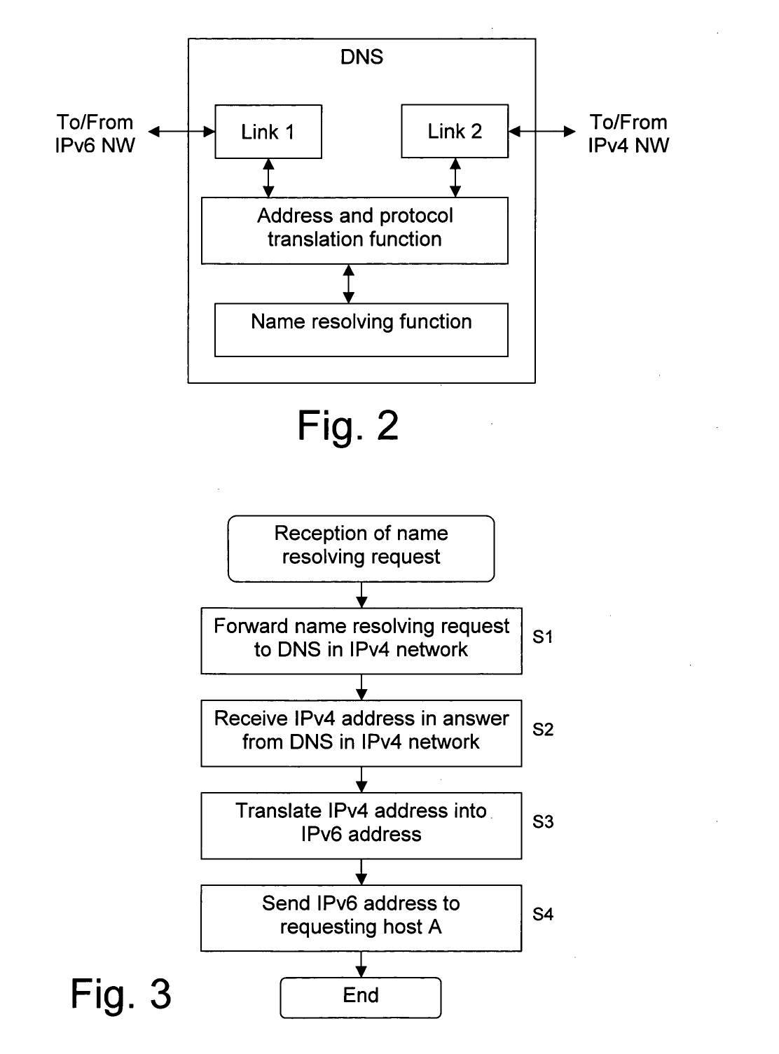

The enhanced DNS server according to the embodiment is illustrated in FIG. 2. As shown, the DNS server comprises a name resolving function (i.e., the function to which the DNS server is dedicated) by which name resolve requests are handled. In addition, the enhanced DNS server according to the embodiment comprises a direct link connection (indicated by link 1) to the IPv6 network (NW), and a direct link connection (indicated by link 2) to the IPv4 network (NW). Moreover, the enhanced DNS server also comprises an address and protocol translation function. This function has access to the name resolving function and in particular to both direct link connections. Thus, the enhanced DNS server according to the embodiment can perform the name resolving in both networks. The direct link connections and the address and protocol translation functions are the new elements of the DNS server according to the present embodiment.

Thus, all DNS related requests are handled by the enhanced DNS server in IPv6 network. When the DNS server in IPv6 network must forward the request to another DNS server in the IPv4 network, because it cannot handle the request itself, it can send the request to IPv4 network directly.

That is, the request does not need to traverse any NAT-PT server. Hence, this cuts down NAT-PT server's load.

FIG. 3 shows a flowchart of the operation performed by the enhanced DNS server according to the present embodiment as described above.

The procedure starts upon receiving a name resolving request, for example from a host A located in the IPv6 network and requesting to communicate with a host B located in the IPv4 network. In this case it is assumed that the name resolving request cannot be handled by the enhanced DNS according to the present embodiment itself. Hence, in step S1, the name resolving request is forwarded to a DNS in the IPv4 network. In step S2, after a successful name resolving in the DNS in the IPv4 network, the IPv4 address is received in an answer from the IPv4 DNS. In step S3, the IPv4 address is translated into an IPv6 address, and this IPv6 address of the host B is transmitted to the host A. Thus, host A can communicate with host B.

Furthermore, in a big IPv6 network, there may be more than just one NAT-PT server in the edge between the two networks. Sometimes, one server may be very busy, while others are free. Moreover, in case a plurality of NAT-PT servers are present, a NAT-PT server adds a specific prefix, e.g., prefix 3ffe:0:1:1::/96 to an IPv4 address when it translates an IPv4 address into an IPv6 address. By this prefix, the particular NAT-PT is identified. That is, different NAT-PT servers have different prefixes.

Thus, according to the present embodiment, also that case is handled in which a plurality of NAT-PT servers are present. That is, when the answer from the DNS server in IPv4 network comes back, the enhanced module (i.e., the address and protocol translation function) in the enhanced DNS server in the IPv6 network may translate the answer by using different NAT-PT server's specific prefix. This forces host A to use a particular NAT-PT server in order to communicate with B.

The rule for the enhanced module in the DNS server in IPv6 network to choose the specific prefix is based on the load information of all the NAT-PT servers. All the NAT-PT servers send their load information, such as the CPU usage, the memory usage etc., to the DNS server in the IPv6 network through SNMP or other protocols timely. The DNS server in the IPv6 network may choose the free NAT-PT server's specific prefix while perform address translation. Then the communication packets will traverse the chosen free NAT-PT server. This can achieve load balance among the NAT-PT servers.

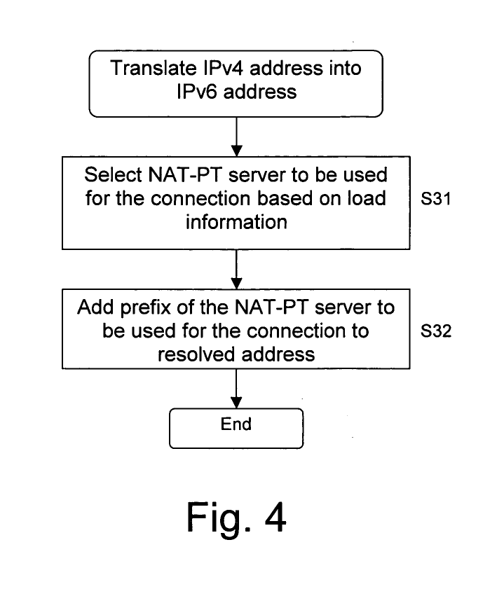

FIG. 4 shows a flow chart of the additional steps which are performed in order to handle a plurality of NAT-PT servers. In particular, these steps are performed within the translation step S3 shown in FIG. 3.

In step S31, a NAT-PT server to be used for the connection is selected based on the load information of the plurality of NAT-PT servers. As described above, the load information may be obtained such that the NAT-PT send their current load condition via SNMP or another suitable protocol to the enhanced DNS server according to the embodiment in regular time intervals. Alternatively, the NAT-PT servers may send the load information only upon a considerable change of the load (e.g., this may be detected by setting corresponding thresholds).

In step S32, the enhanced DNS server (in detail, the address and protocol translation function shown in FIG. 2) adds the prefix of the NAT-PT server to be used for the connection to the resolved address.

In this way, the host which issued a name resolve request is forced to use the selected NAT-PT server to communicate with the resolved host.

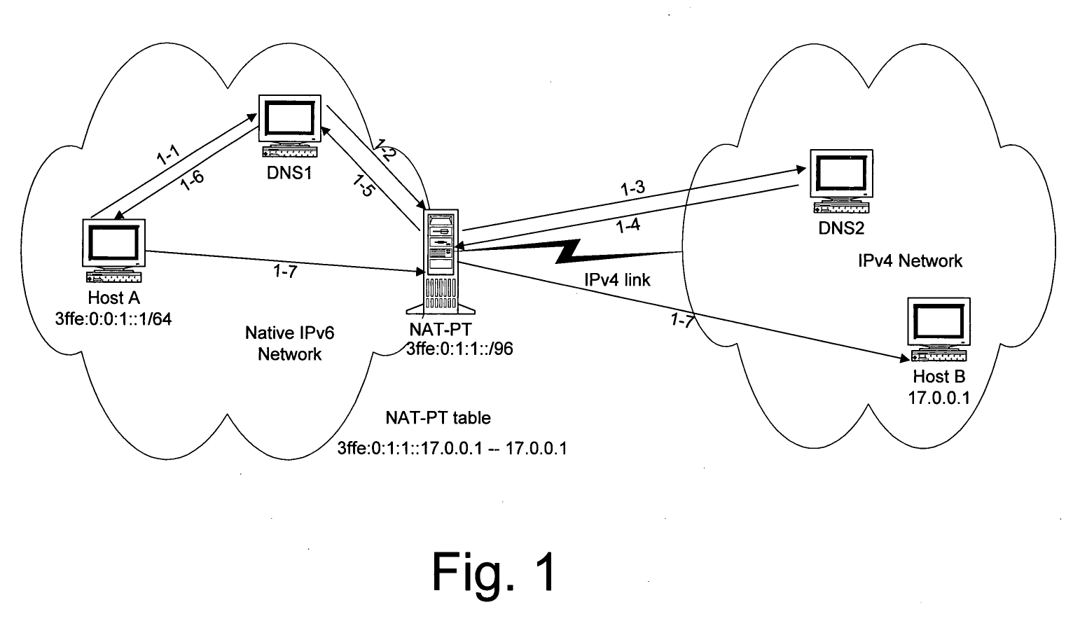

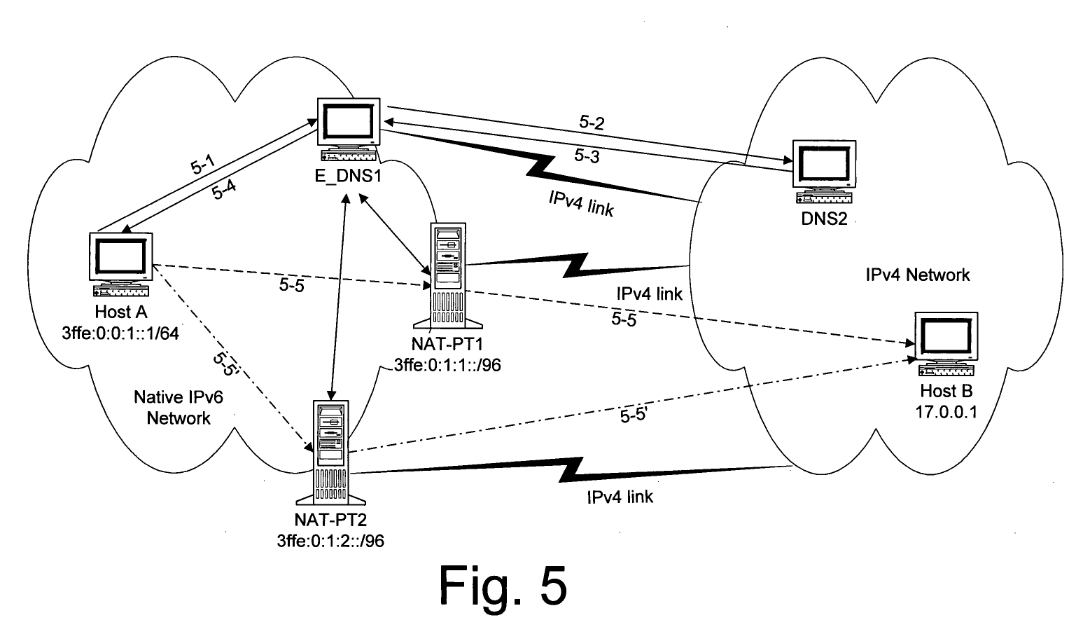

The message flow in a network system is described in the following by referring to FIG. 5. In FIG. 5, the basic situation is similar as that shown in FIG. 1. Namely, two networks having different protocols (IPv4 and IPv6) are present, and normal communication is traversed via NAT-PT server. In this example, two NAT-PT servers are present, namely NAT-PT1 (address prefix 3ffe:0:1:1::/96) and NAT-PT2 (address prefix 3ffe:0:1:2::/96).

The DNS server in this example located in the native IPv6 network is an enhanced DNS server according to the present embodiment and is denoted with E_DNS1. The DNS server in the IPv4 network (denoted by DNS2) is preferably also an enhanced DNS server, but may be also a conventional DNS server. The load information exchanged between NAT-PT1 and NAT-PT2 and the enhanced DNS server is indicated in the figure by the double arrows.

In the following the procedure is described, which is performed when host A wants to establish a connection to host B located in the IPv4 network. In message 5_1, a name resolve request is sent to E_DNS1 in order to get the address of host B. Since host B is not located in the IPv6 network, E_DNS1 cannot handle the request itself. Hence, E_DNS1 forwards the request directly to DNS2 in message 5_2. Namely, as described above the enhanced DNS server E_DNS1 has a dual stack and has a direct link to the IPv4 network. That is, in contrast to the prior art as shown in FIG. 1, the name resolve request forwarded to DNS2 does not have to be transmitted via a NAT-PT server.

The DNS2 resolves the name and sends the answer comprising the address of host B (in this example, 17.0.0.1) back to E_DNS1 in message 5_3. The enhanced DNS server E_DNS1 translates the address of host B into an IPv6 address. In detail, based on the load information of the NAT-PT servers NAT-PT1 and NAT-PT2, E_DNS1 selects that NAT-PT server with the lower load. That is, in case of NAT-PT1, the address of host B (17.0.0.1) is translated into 3ffe:0:1:1::17.0.0.1, and in case of NAT-PT2 the address is translated into 3ffe:0:1:2::17.0.0.1. The translated address is sent to host A in message 5_4. Thereafter, host A can communicate with host B, which is indicated by messages 5_5 and 5_5′.

Namely, in case NAT-PT1 is selected for communication, host A communicates via NAT-PT1 as indicated by messages 5_5. In the figure, this message is denoted by the dashed arrows. That is, in this case host A sends packets to 3ffe:0:11:::17.0.0.1 in order to communicate with host B, such that A's packets traverse NAT-PT1. Thus, a translation table in the NAT-PT server NAT-PT1 indicates 3ffe:0:1:1::17.0.0.1—17.0.0.1.

In case NAT-PT2 is selected, host A communicates via NAT-PT2, as indicated by messages 5_5′. In the figure, this is indicated by the dashed/dotted arrows. Hence, in this case host A sends packets to 3ffe:0:1:2::17.0.0.1 in order to communicate with host B, such that A's packets traverse NAT-PT2. Hence, a translation table in the NAT-PT server NAT-PT2 indicates 3ffe:0:1:2::17.0.0.1—17.0.0.1.

As derivable from a comparison between FIG. 1 illustrating the prior art and FIG. 5 illustrating the embodiment according to the invention, a smaller number of messages is required for a name resolve request traversing a network border. Namely, according to the prior art six messages are required, while according to the present embodiment only four messages are required. Thus, according to the above described embodiment not only the load in the NAT-PT server but also the communication load in the whole network is reduced.

Thus, according to the above described embodiment, the DNS related translation is moved from the NAT-PT server to the enhanced DNS server (dual stack DNS server). By this measure, the load on the NAT-PT server can be cut down.

Furthermore, by using different NAT-PT servers' specific prefix when performing address translation, a load balance between NAT-PT servers can be achieved without any changing to current network system.

The above description and accompanying drawings only illustrate the present invention by way of example. Thus, the embodiment may vary within the scope of the attached claims.

For example, in the above embodiment, a prefix indicating the NAT-PT to be used is added to the resolved address. However, also other indications are possible. For example, information regarding the NAT-PT to be used may be included in a specific control message which is sent to the requesting host. Thereafter, the host (in the above example, host A) can generate the necessary address itself based on this information. Moreover, the indication may be included somewhere else in the translated address message, for example at the end as a suffix.

Moreover, the NAT-PT server described in the above embodiment is only an example for a network address translation device. For example, also a NAT (Network Address Translator) or another suitable network element may be used.

Furthermore, also the illustrated network protocols IPv4 and IPv6 are only examples. Alternatively, also other network protocols are possible.

What is claimed is:

1. A network element for performing name resolving in a network system which includes a first network using a first network protocol and a second network using a second network protocol, the network element comprising:
a first connection means for providing a direct connection to the first network;
a second connection means for providing a direct connection to the second network;
an address translation means for performing address translation between the first network and the second network; and
a name resolving means for performing name resolving,
wherein the name resolving means and the address translation means are adapted to co-operate in order to translate addresses upon performing name resolving.

2. The network element according to claim 1, wherein the network element is a Domain Name Service server.

3. The network element according to claim 1, wherein the address translation means is adapted to select a particular network address translating element to be used for a connection between a first host in the first network and a second host in the second network, and
wherein the address translation means is adapted to add network address translating element information to the resolved address.

4. The network element according to claim 3, wherein the network address translating element information is an address prefix.

5. The network element according to claim 3, wherein the address translation means is adapted to select a network address translating element based on information regarding the load on the network address translating element.

6. The network element according to claim 1, wherein the first protocol is Internet Protocol version 6 (IPv6), and the second protocol is Internet Protocol version 4 (IPv4).

7. The network element according to claim 1, wherein the name resolving means of the network element is adapted to send a name resolve request to a name resolving element located in the second network.

8. A system comprising a network element according to claim 5 and at least two network address translating elements,
wherein the network address translating elements are adapted to send load information to the network element.

9. The system according to claim 8, wherein the load information is sent using a Simple Network Management Protocol (SNMP).

10. A method for resolving names in a network system which includes a first network using a first network protocol and a second network using a second network protocol, comprising the steps of:
processing a name resolve request to obtain an address; and
performing address translation between the first and the second network,
wherein the name resolve request processing step and the step of performing address translation are performed in a dedicated network element for performing name resolving located in the first network and having direct connections to the first network and to the second network.

11. The method according to claim 10, wherein the network element is a Domain Name Service server.

12. The method according to claim 10, wherein the translating step comprises the steps of:
selecting a particular address network translating element to be used for a connection between a first host (A) in the first network and a second host in the second network; and
adding network address translating element information indicating the selected network translating element to the translated address.

13. The method according to claim 12, wherein the network address translating element information is an address prefix.

14. The method according to claim 12, wherein in the selecting step, different network address translating elements are selected based on information regarding the load on the network address translating elements.

15. The method according to claim 10, wherein the first network protocol is Internet Protocol version 6 (IPv6), and the second network protocol is Internet Protocol version 4 (IPv4).

16. The method according to claim 14, further comprising the step of:
sending load information from at least two network address translating elements to the network element.

17. The method according to claim 16, wherein the load information is sent using Simple Network Management Protocol (SNMP).

18. The method according to claim 10, wherein the name resolve request processing step comprises the steps of:
forwarding a name resolve request from the first network directly to a network name resolving element in the second network; and
receiving an address from the name resolving element in the second network.
